(19) United States
(12) Patent Application Publication
(10) Pub. No.: US 2026/0285211 A1
(43) Pub. Date: Sep. 24, 2026

(54) REMOVABLE HEADREST COVERS

(71) Applicant: Toyota Motor Engineering & Manufacturing North America, Inc., Plano, TX (US)

(72) Inventors: William P. Dix, Highland Park, MI (US); Vasudeva S. Murthy, Ann Arbor, MI (US); John D. Harkleroad, Ypsilanti, MI (US); Alexander W. Schuyler, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/085,001

(22) Filed: Mar. 20, 2025

(51) Int. Cl. B60N 2/60; B60N 2/809

(52) U.S. Cl. CPC B60N 2/6036; B60N 2/809

(57) ABSTRACT

Devices and methods described herein relate to a headrest cover that includes a material sleeve sized to cover a front surface, a rear surface, a top surface, a first side surface, and a second side surface of a headrest of a seat. The headrest cover includes a first zipper portion disposed around a bottom edge of the material sleeve. The first zipper portion is adapted to be joined with a second zipper portion affixed around a perimeter of a bottom surface of the headrest.

### TECHNICAL FIELD

The subject matter described herein relates, in general, to vehicle seat upholstery and, more particularly, to a removable headrest cover adapted to be applied to a headrest of a vehicle seat and a headrest adapted to be joined to the vehicle seat.

### BACKGROUND

Vehicle passengers may spend many hours, sometimes in a single day, traveling in a vehicle. Given these durations, an individual may desire a comfortable and ergonomic seat that prevents discomfort and pain, and that is aesthetically pleasing. Generally, a seat includes a headrest or a head restraint mounted to the backrest of a vehicle seat. The headrest or head restraint may provide a surface against which an occupant may rest their head. The headrest or head restraint may also prevent injury or reduce the severity of injury to an occupant due to a collision. For example, the head restraint may prevent a sudden rearward motion of the head of the occupant, which may occur when energy from a collision is transferred to the occupant.

An outer layer wrapped around the padded cushions provides a comfortable, supportive, and aesthetically pleasing exterior surface. Over time and during the ordinary course of use, the outer layer of the headrest may become worn down or damaged, resulting in thin spots, tears, etc. Moreover, from time to time, the outer layer may become soiled or stained. For example, individuals may eat food or consume beverages in their vehicle. The food and/or beverages may spill and soil the material cover.

### SUMMARY

In one aspect of the embodiments described herein, a headrest cover is described. The headrest cover includes a material sleeve sized to cover a front surface, a rear surface, a top surface, a first side surface, and a second side surface of a headrest of a seat. The headrest cover also includes a first zipper portion disposed around a bottom edge of the material sleeve. The first zipper portion is adapted to be joined with a second zipper portion affixed around a perimeter of a bottom surface of the headrest.

In one aspect of the embodiments described herein, a headrest is described. The headrest includes a padded cushion and support rods. The support rods are within the padded cushion and extend through a bottom surface of the padded cushion. The support rods are adapted to slide into headrest channels in a seat. The headrest also includes a second zipper portion disposed around a perimeter of a bottom surface of the padded cushion. The second zipper portion is adapted to be joined with a first zipper portion disposed around a bottom edge of a headrest cover.

In one aspect of the embodiments described herein, a headrest cover is described. The headrest cover includes a material sleeve sized to cover a front surface, a rear surface, a top surface, a first side surface, and a second side surface of a headrest of a seat. The headrest cover also includes a cover attachment structure. The cover attachment structure extends inward from a headrest-facing surface of the material sleeve. The cover attachment structure is adapted to mate with a headrest attachment structure that is affixed to an exterior surface of the headrest.

In one aspect of the embodiments described herein, a headrest is described. The headrest includes a padded cushion and support rods. The support rods are within the padded cushion and extend through a bottom surface of the padded cushion. The support rods are adapted to slide into headrest channels in a seat. The headrest also includes a headrest attachment structure. The headrest attachment structure is affixed to an exterior surface of the headrest attachment structure. The headrest attachment structure is adapted to mate with a cover attachment structure that extends inward from a headrest-facing surface of a headrest cover.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 is an exploded isometric view of a headrest cover with zipper attachments and a base headrest cover according to an embodiment described herein.

FIG. 2 is an exploded isometric view of a headrest cover with zipper attachments and an impermeable bag according to an embodiment described herein.

FIG. 3 is a flowchart depicting a method of forming a headrest cover with zipper attachments according to an embodiment described herein.

FIG. 4A-4D depict the formation of a headrest cover with zipper attachments according to an embodiment described herein.

FIG. 5 is an assembled isometric view of a headrest cover with zipper attachments according to an embodiment described herein.

FIGS. 6A and 6B are views of a headrest cover with an integrated bolster according to an embodiment described herein.

FIGS. 7A and 7B are views of a headrest cover with integrated attachment structures according to an embodiment described herein.

FIG. 8A-8F are views of a headrest cover with integrated attachment structures according to embodiments described herein.

FIG. 9A-9D are views of a headrest cover with integrated attachment structures according to embodiments described herein.

FIG. 10 is a flowchart depicting a method of forming a headrest cover with integrated rigid attachment structures according to an embodiment described herein.

FIG. 11A-11C depict the formation of a headrest cover with integrated attachment structures according to an embodiment described herein.

FIG. 12 is a flowchart depicting a method of installing a headrest cover in accordance with an embodiment described herein.

### DETAILED DESCRIPTION

Systems, methods, and other embodiments associated with improving vehicle upholstery comfort, durability, and maintenance are disclosed herein. As described above, vehicle headrests may be adorned with a material outer layer that 1) conceals the headrest cushion and 2) provides an aesthetically pleasing and comfortable surface on which the driver or occupant may rest their head. However, over time, the material that makes up the cover may wear down or become damaged, stained, or soiled. As an example, a passenger may spill a beverage from a container onto the headrest. This liquid may stain the surface of the material cover. In another example, the cover may become worn down over time. For example, repeated friction with the head of a driver or a hat worn by the driver may cause the cover to become thin in spots and/or tear.

Still further, a user may desire to change the aesthetic of the headrest, for example, to reflect the driver's support of a particular sports team. As another example, a user may utilize the vehicle in certain settings where particular materials may be beneficial as a headrest cover. For example, a user may frequent the waterfront or rainy, snowy environments such that a waterproof headrest cover may be beneficial. As yet another example, the interior of the vehicle may be prone to abrasion. In this example, an anti-abrasion material (e.g., a ripstop fabric) may provide more protection to the headrest than fabric-based materials.

In these cases and others, repairing, removing, or replacing the material cover may be expensive, complex, and time-consuming. In some cases, the material cover is inseparable from the headrest body. Accordingly, when the material cover becomes damaged, a user may be required to replace the entire headrest, even if the padded cushion is undamaged. Replacing an entire vehicle headrest when just a headrest outer fabric material is damaged is wasteful and not cost-efficient. Accordingly, the headrest cover of the present specification, rather than requiring the replacement of the entire headrest when the cover becomes damaged, facilitates the facile replacement of just the exterior cover of the headrest.

Specifically, the present specification describes headrest covers that are draped over the headrest of a seat. The headrest covers are selectively removable by a consumer. The present specification also describes headrests that facilitate the facile removal of the headrest cover.

In one example, the removable headrest cover includes a material sleeve sized to cover a front surface, a rear surface, a top surface, a first side surface, and a second side surface of a headrest of a seat. The headrest cover also includes a first zipper portion disposed around the bottom edge of the material sleeve. In this example, the headrest includes a second zipper portion that mates with the first zipper portion. The second zipper portion may be affixed to a base headrest cover attached to the padded cushion or an impermeable bag that envelopes the padded cushion. In either example, the second zipper portion may be disposed around a perimeter of the bottom surface of the headrest.

In this example, the headrest may be formed via a pour-in-place operation where foam or liquid reactants are poured into a mold that is 1) in the shape of the headrest and, in some examples, 2) interlaid with the impermeable bag. In some examples, before the foam or liquid reactants are injected, a base headrest cover may be affixed to the headrest mold. During curing, the base headrest cover or the impermeable bag may be adhered to the foam. The second zipper portion may be integrated with either the base headrest cover or the impermeable bag. In either case, in this embodiment, the headrest cover is attached to the base material via a zippered attachment.

In an example, the headrest cover and the headrest both have attachment structures, which may be rigid or flexible, that facilitate a sturdy connection of the headrest cover to the headrest. More specifically, the headrest cover may include any variety of different attachment structures formed on the headrest-facing surfaces of the material sleeve. These cover attachment structures may be sewn into the material sleeve. The padded cushion of the headrest includes corresponding attachment structures embedded into the cushion. For example, the attachment structures may be placed in a mold during manufacturing. The features become embedded in the foam body as foam or liquid reactants are poured into the mold. During installation, the headrest cover is attached to the headrest via the engagement of the corresponding attachment structures. Example attachment structures include press fit or compression clips, snaps, hook-shaped channels, keyed cylinders, hook-and-loop fasteners, and zippers.

Accordingly, these described embodiments facilitate the facile replacement and/or repair of the headrest material component without requiring the replacement of the entire headrest. The headrest covers also facilitate the simple customization and alteration of the headrest.

As used herein, the term “upper” refers to a vertically relatively higher position or location, and “lower” refers to a vertically relatively lower position or location, from the perspective of an occupant seated in the vehicle seat when the seat is mounted in a vehicle and the vehicle rests on a ground surface. Similarly, the term “left” refers to a direction on or toward a left side from the perspective of an occupant seated in the vehicle seat when the seat is mounted in a vehicle, and the vehicle rests on a ground surface. Also, the term “right” refers to a direction on or toward a right side from the perspective of an occupant seated in the vehicle seat when the seat is mounted in a vehicle, and the vehicle rests on a ground surface.

Moreover, as used herein, the term “material” may refer to natural or synthetic fabrics. Examples of fabrics include cloth and Duon®, among others. The material may be of other types as well, such as natural or synthetic materials, such as polyurethane, polyvinyl chloride (PVC), and/or leather. In an example, the material could be perforated to accommodate ventilation. While the present specification refers to particular materials from which components of the headrest cover may be formed, these components may be formed of other materials and/or combinations of these and other flexible materials, including those that are not yet developed.

It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. Moreover, note that the presence of a “-*” indicator following a reference number indicates a specific instance of the component, while the absence of the “-*” indicator indicates a general instance of the component.

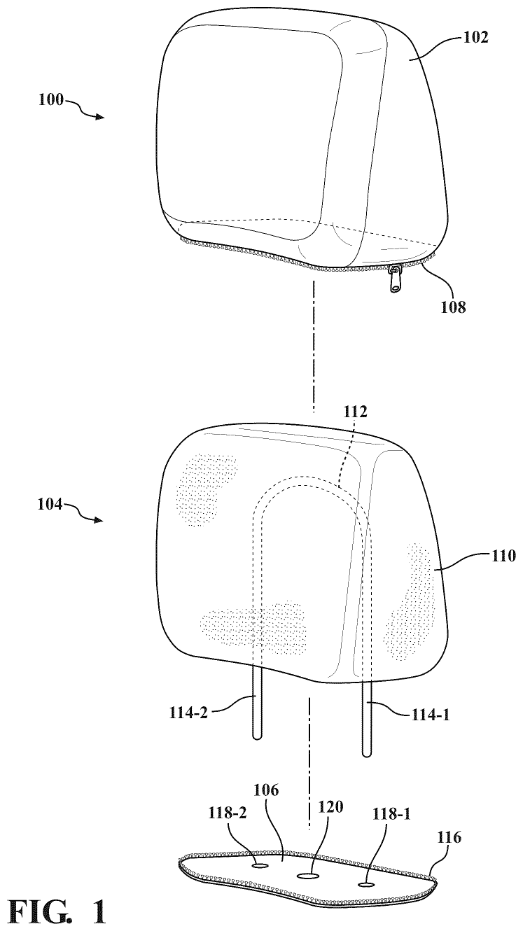

Turning now to the figures, FIG. 1 is an exploded isometric view of a headrest cover 100 with zipper attachments and a base headrest cover 106 according to an embodiment described herein. As described above, a vehicle seat may include a headrest 104, against which passengers may rest their heads. As such, the headrest 104 may reduce the strain and fatigue that a passenger may experience, especially on long trips. The headrest 104 may also promote proper driver ergonomics by supporting good driving posture. The headrest 104 may also prevent unsafe backward movement of the passenger's head (e.g., whiplash), which may occur, for example, during an accident. In general, a headrest 104 includes a padded cushion 110. The padded cushion 110 provides a soft surface against which an occupant may rest their head and that absorbs energy during a collision. The padded cushion 110 may be formed of various materials, such as polyurethane foam and memory foam.

The headrest 104 also includes a headrest stay 112, which may include support rods 114-1 and 114-2 that are within the padded cushion 110 and that extend out a bottom surface of the padded cushion 110. The support rods 114-1 and 114-2 slide into headrest channels in the seat. In an example, the support rods 114-1 and 114-2 vertically translate within the headrest channels, such that the headrest 104 is adjustable to different heights to accommodate occupants with different heights. Via any number of mechanisms, the support rods 114-1 and 114-2 may be held at a particular vertical position within an associated headrest channel.

As described above, some headrest assemblies also include a fabric cover. As described above, the fabric cover may become worn down, damaged, or soiled. In some cases, the fabric cover is integrated with the padded cushion 110, such that it may be difficult, if possible, to separate and individually replace the headrest fabric cover. Accordingly, the present specification describes headrest covers that are removably attachable from the headrest 104 itself. That is, the headrest cover 100 may include a material sleeve 102 that is removably attachable to the headrest 104. The selective separation of the headrest cover 100 from the headrest 104 may be accomplished in various ways. In the example depicted in FIG. 1-6B, the headrest cover includes a first zipper portion 108, and the headrest includes a second zipper portion 116.

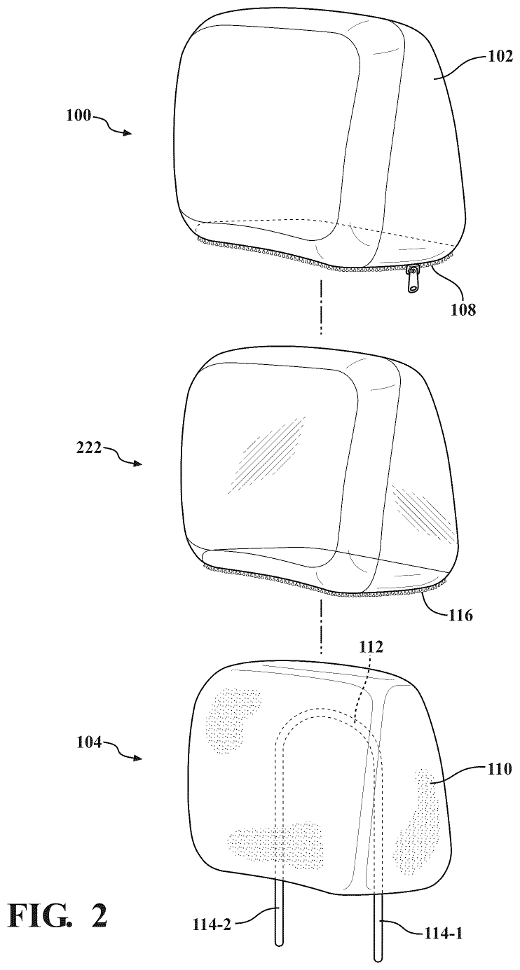

In this example, the headrest cover 100 includes a material sleeve 102 sized to cover a front surface, a rear surface, a top surface, a first side surface, and a second side surface of a headrest 104 of a seat. That is, the headrest 104 may have a generally cuboidal shape, having a front surface (i.e., a surface facing the occupant), a rear surface (i.e., a surface facing away from the occupant), a top surface, side surfaces, and a bottom surface (i.e., a surface facing the seat when the support rods 114-1 and 114-2 are inserted into respective headrest channels). The material sleeve 102 may be formed to cover the front, rear, top, and side surfaces of the headrest 104. By comparison, the bottom surface of the headrest 104 may be covered by a base headrest cover 106, as depicted in FIG. 1, or uncovered, as depicted in FIG. 2.

The material sleeve 102 may be formed of a variety of materials, including fabric, polyurethane, PVC, a ripstop fabric, and/or leather. By comparison, the base headrest cover 106, on account of being less visible and less susceptible to wear, damage, and or becoming soiled, may be formed of a different material, such as Duon®, that is less resistant than the material of the material sleeve 102.

In either case, the headrest cover 100 includes a first zipper portion 108 disposed around the bottom edge of the material sleeve 102. A zipper refers to two sets of teeth on separate strips of material that are pulled together by the application of an associated slider and a pull tab to join two objects, in this case, the material sleeve 102 and the base headrest cover 106. A “zipper portion” may be a portion of a zipper (e.g., a set of zipper teeth, a slider, etc.) operably connected to and/or structured to interact with another portion (i.e., a complementary, mating set of teeth) of the zipper.

The headrest cover 100 includes a first zipper portion 108, disposed around the bottom edge of the material sleeve 102. The first zipper portion 108 is adapted to be joined with a second zipper portion 116 affixed around the perimeter of the bottom surface of the headrest 104. The headrest 104 includes a second zipper portion 116 disposed around the perimeter of the bottom surface of the padded cushion 110. The second zipper portion 116 is adapted to be joined with the first zipper portion 108, which is disposed around the bottom edge of the headrest cover. In the example depicted in FIG. 1, the second zipper portion 116 is disposed on the base headrest cover 106 of the headrest 104.

As depicted in FIGS. 1 and 2, the first zipper portion 108 may extend around an entire bottom edge of the material sleeve 102. FIG. 1 depicts the slider of the zipper (and thus the box pin of the zipper) being formed on the first zipper portion 108 of the material sleeve 102 with the second zipper portion 116 and the insertion pin of the zipper being formed on the base headrest cover 106. However, in an example, the slider and box pin of the zipper may be included on the base headrest cover 106 (i.e., as a portion of the second zipper portion 116), with the insertion pin of the zipper being formed on the material sleeve 102 as part of the first zipper portion 108. Both the first zipper portion 108 and the second zipper portion 116 may be sewn to their respective joining bodies. That is, the first zipper portion 108 may be sewn to the material sleeve 102, while the second zipper portion 116 may be sewn to the base headrest cover.

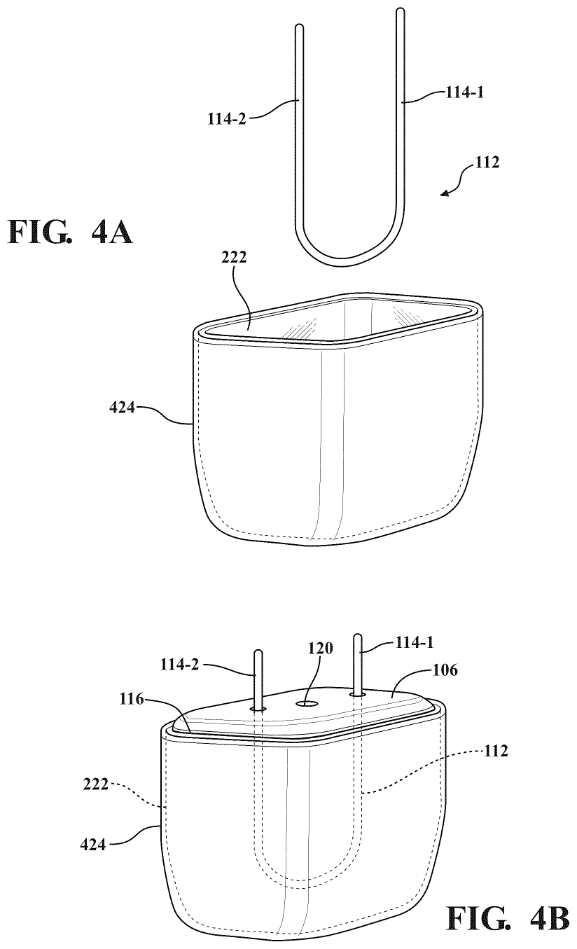

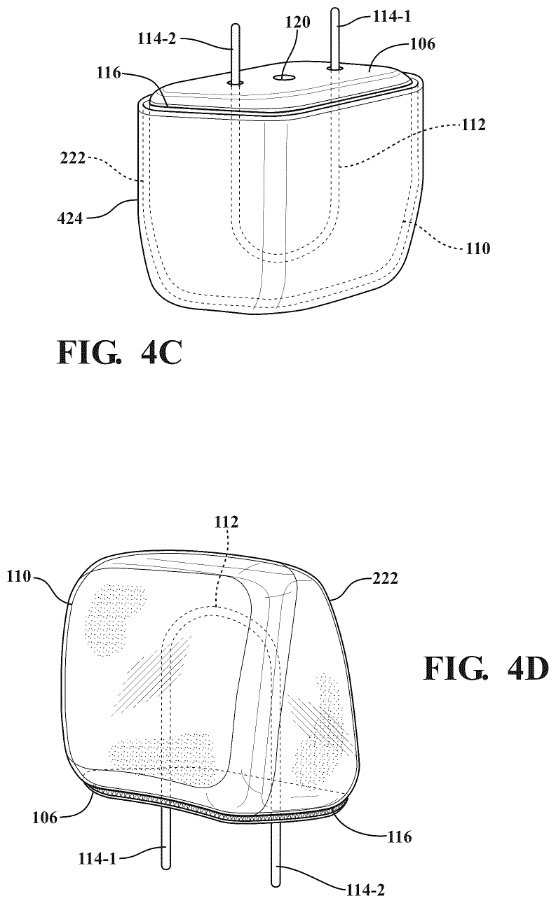

In the example depicted in FIG. 1, the headrest cover 100 also includes a base headrest cover 106 that is sized to cover the bottom surface of the padded cushion 110 and is also attached to the bottom surface of the padded cushion 110. Additional details regarding the attachment of the base headrest cover 106 to the padded cushion 110 are provided below in connection with FIG. 4A-4D.

The base headrest cover 106 may include additional components that facilitate attachment of the headrest 104 to the seat and formation of the headrest 104. For example, the base headrest cover 106 may include rod apertures 118-1 and 118-2 through which the support rods 114-1 and 114-2 pass during assembly. As another example, the base headrest cover 106 may include an injection aperture 120, through which foam or liquids may be injected into a mold to form the headrest 104. Additional details regarding the injection of foam or liquids through the injection aperture 120 are provided below in connection with FIG. 4A-4D.

FIG. 2 is an exploded isometric view of a headrest cover 100 with zipper attachments and an impermeable bag 222, according to an embodiment described herein. In the example depicted in FIG. 2, the second zipper portion 116, which is attachable to the first zipper portion 108 of the material sleeve 102, is formed on an impermeable bag 222. That is, in this example, the headrest 104 includes an impermeable bag 222 that covers a front surface, a rear surface, a top surface, a first side surface, and a second side surface of the padded cushion 110. In an example, the impermeable bag 222 may be permanently attached to the padded cushion 110. For example, as depicted below in FIG. 4A-4D, the impermeable bag 222 may be inserted into the mold where the foam or liquid reactants for the padded cushion 110 are injected. As the foam cures, the impermeable bag 222 may be bonded (for example, via lamination bonded) or otherwise permanently adhered to the padded cushion 110. In an example, the impermeable bag 222 may be formed of a non-permeable, non-porous plastic material. Examples of such materials include polyethylene, polyvinyl chloride, or polypropylene. This impermeable bag 222 may provide a moisture barrier to the padded cushion 110.

As depicted in FIG. 2, the second zipper portion 116 is attached to an edge of the impermeable bag 222. This may be performed in a variety of ways, including heat staking, where heat and pressure are applied to join two plastic components (i.e., the second zipper portion 116 strip and the impermeable bag 222), vibration welding, where vibration and friction from a tool heat two plastic components (i.e., the second zipper portion 116 strip and the impermeable bag 222) and join such together, radio frequency (RF) welding where vibrating the molecules generates heat that join the two components (i.e., the second zipper portion 116 strip and the impermeable bag 222), or bonding via an adhesive.

As the impermeable bag 222 is permanently attached to the padded cushion 110, the joining of the first zipper portion 108 and the second zipper portion 116 may result in a strong attachment of the headrest cover 100 to the headrest 104. Note that in this example, the bottom surface of the headrest 104 may be exposed. However, this surface is not visible because it is adjacent to the vehicle seat, and the exposure of the bottom surface may be permissible as this portion of the padded cushion 110 is not as susceptible to damage or wear.

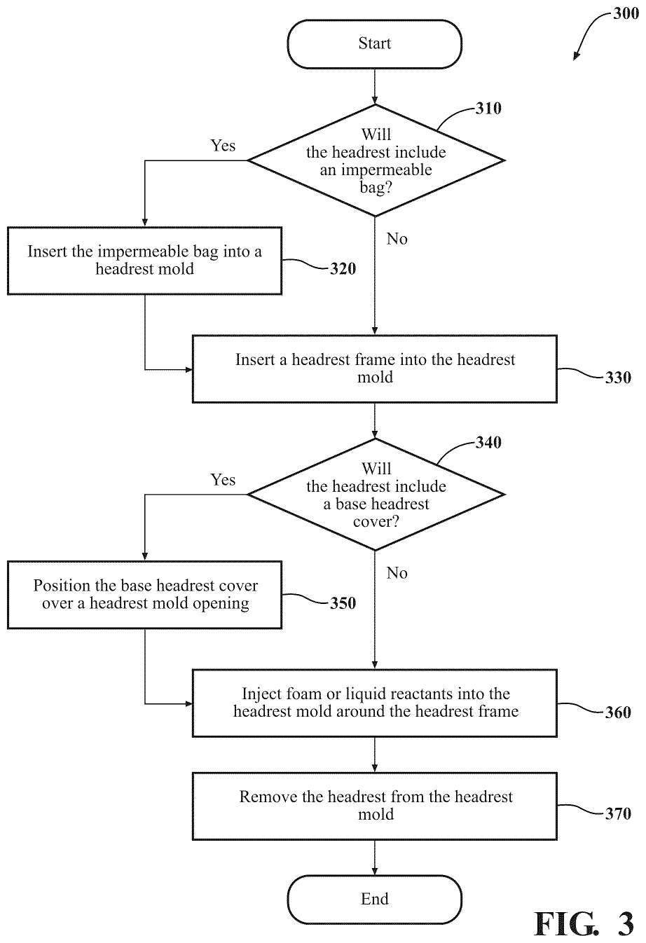

FIG. 3 is a flowchart depicting a method 300 of forming a headrest cover 100 with zipper attachments according to an embodiment described herein. FIG. 4A-4D pictorially represent the steps described herein.

As described above, the headrest 104 may include an impermeable bag 222, a base headrest cover 106, or both. The components that make up the headrest 104 may define the manufacturing parameters executed. Accordingly, at 310, it is determined whether the headrest 104 will include an impermeable bag 222. If so, at 320, the impermeable bag 222 is inserted into the headrest mold 424. Specifically, a non-porous impermeable bag 222, such as a polyethylene, a polyvinyl chloride, or a polypropylene bag, may be inserted into the headrest mold 424 as depicted in FIG. 4A. The impermeable bag 222, in addition to providing a moisture barrier to the padded cushion 110 during use, may also prevent adhesion between the headrest mold 424 and the padded cushion 110 and/or the foam/liquid reactants that react to form the padded cushion 110. However, in some examples, the headrest 104 may not include an impermeable bag 222 surrounding the padded cushion 110.

In either case, at 330, as depicted in FIG. 4A, the headrest stay 112 (along with the attached support rods 114-1 and 114-2) may be inserted into the headrest mold 424. The headrest mold 424 is an injection cavity formed in a target shape for the headrest 104 such that when foam or liquid reactants are added therein and allowed to expand and cure, the foam takes the form of the headrest mold 424, which is the desired shape for the headrest 104.

Again, it may be the case that the headrest 104 does not include a base headrest cover 106. Accordingly at 340, it is determined whether the headrest 104 is to include a base headrest cover 106. If so, at 350, as depicted in FIG. 4B, the base headrest cover 106 is positioned over an opening of the headrest mold 424. Specifically, the support rods 114-1 and 114-2 are inserted through the rod apertures 118-1 and 118-2 of the base headrest cover 106. In this example, where the headrest 104 includes an impermeable bag 222 and a base headrest cover 106, the base headrest cover 106 may be affixed to the impermeable bag 222. That is, the base headrest cover 106 may be attached to an impermeable bag 222 that covers a front surface, a rear surface, a top surface, a first side surface, and a second side surface of the padded cushion.

Specifically, the edges of the base headrest cover 106 may be sewn to the impermeable bag 222. In another example, an adhesive may be placed between the base headrest cover 106 and the impermeable bag 222. While specific reference is made to particular joining operations, the base headrest cover 106 may be adhered to the impermeable bag 222 in other ways including, but not limited to, vibration welding, heat staking, or RF welding. In another example, the base headrest cover 106 may not be joined to the impermeable bag 222. Rather, the base headrest cover 106 may sit across the opening of the headrest mold 424 with the edge of the base headrest cover 106 adjacent to the edges of the impermeable bag 222.

As described above, if the headrest 104 does not include an impermeable bag 222, the base headrest cover 106 may include the second zipper portion 116, which may be sewn, joined via adhesive, heat-staking, vibration welding, or RF welding, to the base headrest cover 106. If the headrest 104 includes an impermeable bag 222 but does not include a base headrest cover 106, the second zipper portion 116 may be joined to the impermeable bag 222, for example, via an adhesive, heat-staking, vibration welding, or RF welding. In an example as depicted in FIGS. 4A-4D, the headrest 104 may include an impermeable bag 222 and a base headrest cover 106. In this example, the second zipper portion 116 may be joined to either component.

In either case, at 360, foam or liquid reactants may be injected into the headrest mold 424 around the headrest stay 112 as depicted in FIG. 4C. In the case where the headrest 104 includes the base headrest cover 106, the base headrest cover 106 may include an injection aperture 120. The injection aperture 120 receives a nozzle through which the foam or liquid reactants are injected into the headrest mold 424 to form the padded cushion 110. In the case where the headrest 104 does not include the base headrest cover 106, the foam or other reactant is injected into an opening of the headrest mold 424, which opening is depicted in FIG. 4A.

The injected material may take a variety of forms. For example, liquid foam may be injected into the headrest mold 424. The injected liquid foam may take a variety of forms. For example, the foam may be an open-cell foam, a closed-cell foam, or other injectable-type foam. In an example, the foam is an expandable foam that, when injected into the headrest mold 424, expands to fill the volume of the injection cavity.

In another example, liquid reactants, rather than foam, are injected into the headrest mold 424, with or without the impermeable bag 222. For example, different liquids may be injected into the headrest mold 424. A chemical reaction between these liquids may result in the polyurethane foam that makes up the padded cushion 110. While particular reference is made to particular injectable components (i.e., liquids or foams), other types of injectable liquids and/or foams may be implemented in accordance with the principles described herein.

During curing, the impermeable bag 222 and the base headrest cover 106, if present, may adhere or bond to the curing foam. For example, the base headrest cover 106 may be a porous material, with particles of foam entering the spaces between pores of the base headrest cover 106 and adhering to such. As another example, the curing process may be exothermic, with generated heat at least partially melting the impermeable bag 222 to the padded cushion 110. That is, the curing process may trigger a chemical or thermal process by which the base headrest cover 106 and/or the impermeable bag 222 are permanently attached to the cured padded cushion.

In another example, an adhesive may be applied to the interior-facing surfaces of the impermeable bag 222 and/or the base headrest cover 106, which adhesive permanently attaches the impermeable bag 222 and/or the base headrest cover 106 to the padded cushion 110.

As described above, the base headrest cover 106 may include the second zipper portion 116 (as depicted in FIGS. 1 and 4B-4D), or the impermeable bag 222 may include the second zipper portion 116 (as depicted in FIG. 2). In either case, the headrest 104 includes a second zipper portion 116 which is joined to the first zipper portion 108 of the removable headrest cover 100 to facilitate removal of the headrest cover 100 from the headrest 104.

In either case, at 370, as depicted in FIG. 4D, the headrest 104 is removed from the headrest mold 424. As described above, the padded cushion 110 1) has the shape of the headrest mold 424 and 2) has the base headrest cover 106 and/or an impermeable bag 222 affixed thereto. On account of the integrated second zipper portion 116 on the headrest 104, the headrest cover 100, via its first zipper portion 108, may be removably attached to the headrest 104.

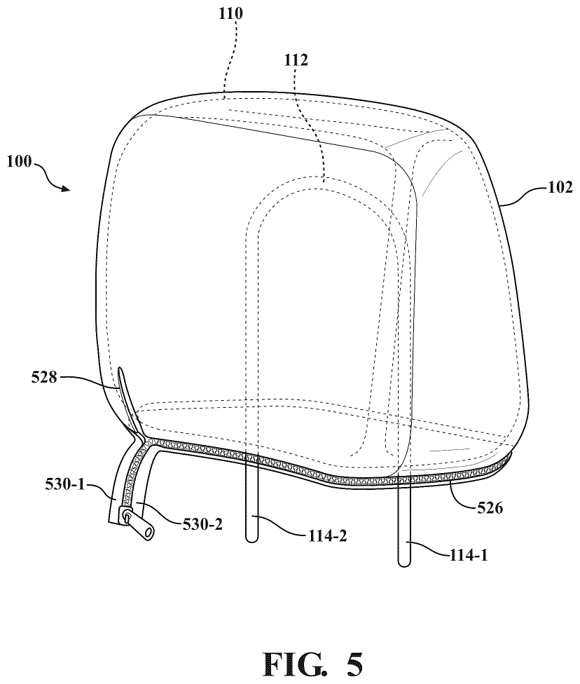

FIG. 5 is an assembled isometric view of a headrest cover 100 with zipper attachments according to an embodiment described herein. Specifically, FIG. 5 is a backside view of a headrest cover 100 assembled over a headrest 104. As depicted in FIG. 5, the headrest cover 100 has been joined to the headrest (i.e., the base headrest cover 106 or the impermeable bag 222 of the headrest 104) via a zipper 526.

FIG. 5 also depicts additional components which may be found on the headrest cover 100. Specifically, the headrest cover 100 may include a relief structure 528 on the material sleeve 102 that expands as the material sleeve 102 is wrapped over the headrest 104. That is, to ensure a desirable look and to preserve the functionality and comfort of the headrest 104, it may be desirable for the headrest cover 100 to fit tightly over the headrest 104. Ensuring a snug fit may complicate installation as it may be difficult to wrap an inelastic or nominally elastic material (e.g., leather, fabric, etc.) over the headrest 104. That is, a leather or fabric material sleeve 102 may not stretch, or stretch to a small degree, such that it may be difficult to wrap the material sleeve 102 over the headrest 104. To address this, the material sleeve 102 may be enlarged to facilitate installation over a headrest 104. However, an enlarged material sleeve 102 may not fit snugly against the headrest 104, giving an undesired aesthetic and structural form to the headrest cover 10. Accordingly, the relief structure 528 may slightly enlarge the opening through which the headrest 104 is inserted into the headrest cover 100. As depicted in FIG. 5, the relief structure 528 may be formed on the back side of the material sleeve 102. In other examples, the relief structure 528 may be formed on other surfaces, such as a side surface of the material sleeve 102.

The relief structure 528 may take various forms. In one example, the relief structure may be an open slit in the material sleeve 102. In this example, the edges of the slit may be sewn to prevent fraying of the material sleeve 102 body. In another example, the slit in the material sleeve 102 may be filled with an elastically deformable material, with the elastic deformation of the slit material being different than that of the material of the material sleeve 102. For example, the slit may be filled with a ribbed knit material or an elastic-infused material. In either case, the relief structure 528 may facilitate easy removal of the headrest cover 100 while preserving a snug fit over the headrest 104.

The zipper 526 may also include a tail section extending away from the headrest 104. Specifically, the first zipper portion 108 may include a first zipper tail section 530-1 that extends away from the material sleeve 102. The first zipper tail section 530-1 may be adapted to join with a second zipper tail section 530-2 that extends away from the headrest 104. Similarly, the second zipper portion 116 may include the second zipper tail section 530-2 that extends away from the headrest 104 and is adapted to join with a first zipper tail section 530-1 that extends away from the material sleeve 102. The tail section may facilitate the joining of the first zipper portion 108 and the second zipper portion 116. That is, by being removed from the headrest 104 and the headrest cover 100, a user may more easily handle the zipper portions to align the slider to the insert pin of the zipper 526.

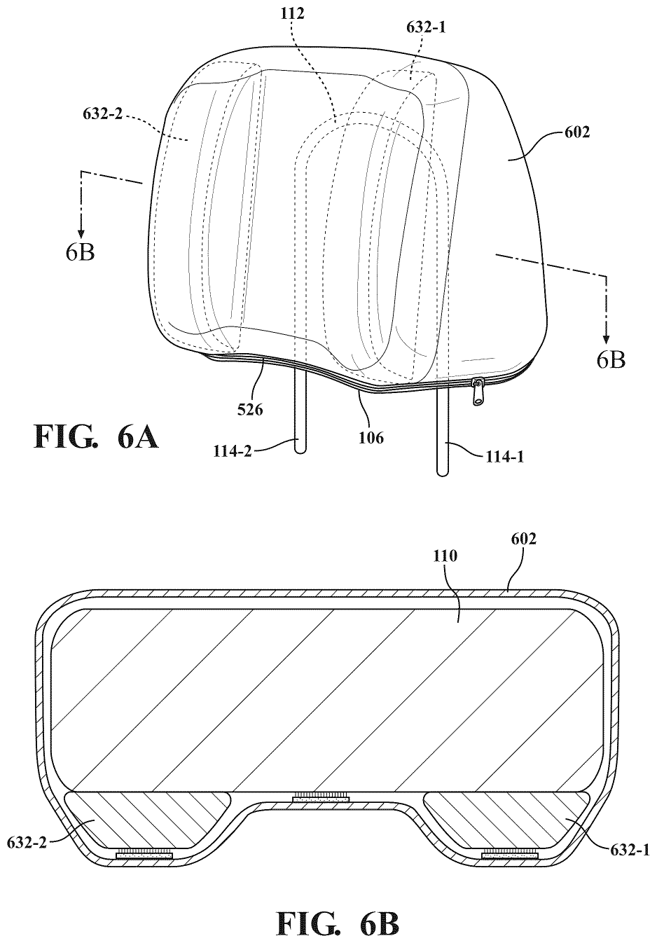

FIGS. 6A and 6B are views of a headrest cover 600 with integrated bolsters 632-1 and 632-2, according to an embodiment described herein. Specifically, FIG. 6A is an isometric view of a headrest cover 600 with integrated bolsters 632-1 and 632-2. In the example depicted in FIGS. 6A and 6B, the headrest cover 600 further includes bolsters 632-1 and 632-2 on a headrest-facing side of the front surface of the material sleeve 602. That is, the headrest cover 600 may include a support structure to provide extra cushion for a passenger, for example, to keep the head of a passenger generally centered and/or to prevent unnecessary or undesirable side-to-side motion. The bolsters 632-1 and 632-2 are depicted in dashed lines in FIG. 6A to indicate their position on an interior surface (facing the headrest as opposed to facing the occupant) of the material sleeve 602. While FIG. 6A depicts particular bolsters 632-1 and 632-2 having particular shapes and sizes, differently shaped and/or sized bolsters 632-1 and 632-2 may be included herein and affixed to the headrest-facing surface of the material sleeve 602. FIG. 6B depicts a cross-sectional view of the headrest cover 600 of FIG. 6A, specifically taken along the line 6B in FIG. 6A. As depicted in FIG. 6B, the bolsters 632-1 and 632-2 are separate from the padded cushion 110 that forms the body of the headrest 104 and are attached to an interior surface of the material sleeve 602. In other words, the bolsters 632-1 and 632-2 are separate components that are added to the material sleeve 602 to customize the shape of the headrest. Accordingly, a headrest 104 that may otherwise not have ergonomic contours may be supplemented with such. The bolsters 632-1 and 632-2 may be sewn into or otherwise semi-permanently attached (e.g., via an adhesive) to the headrest-facing side of the front surface of the material sleeve 602. In other examples, the bolsters 632-1 and 632-2 are removably attached to the headrest-facing side of the front surface of the material sleeve 602. For example, the bolsters 632-1 and 632-2 may be attached to the headrest-facing side of the front surface of the material sleeve 602 via a hook-and-loop fastener. Accordingly, in this example, the bolsters 632-1 and 632-2 may be removed from the material sleeve 602 to facilitate cleaning, repair, and/or replacement of the material sleeve 602 and/or the bolsters 632-1 and 632-2. In an example, the material sleeve 602 may further include a hook-and-loop fastener that attaches directly to the padded cushion 110. This cushion-attaching hook-and-loop fastener may ensure that the headrest cover 600 follows the contours of the padded cushion 110.

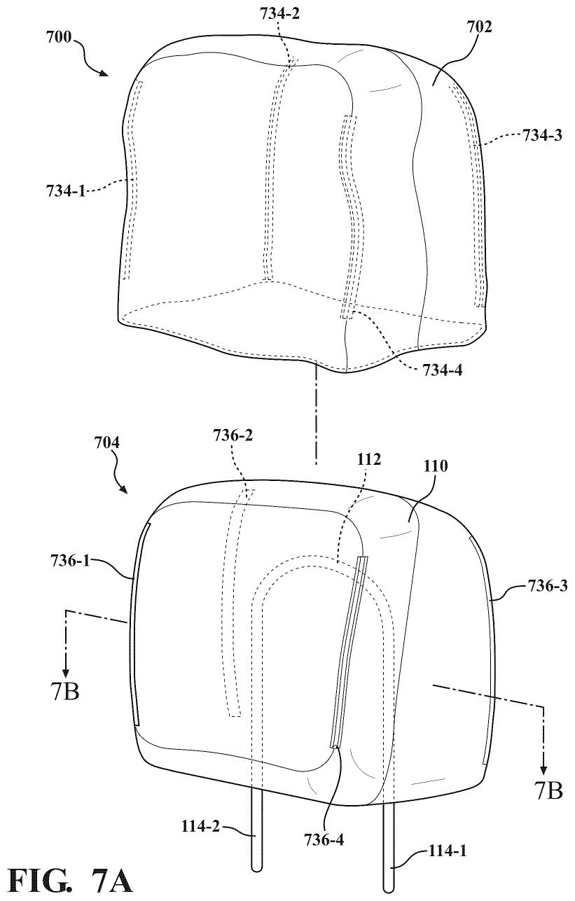

FIGS. 7A and 7B are views of a headrest cover 700 with integrated attachment structures according to an embodiment described herein. Specifically, FIG. 7A is an exploded isometric view of the headrest cover 700 with integrated attachment structures and FIG. 7B is a cross-sectional view of an assembled headrest cover 700 with attachment structures, taken along the line 7B in FIG. 7A.

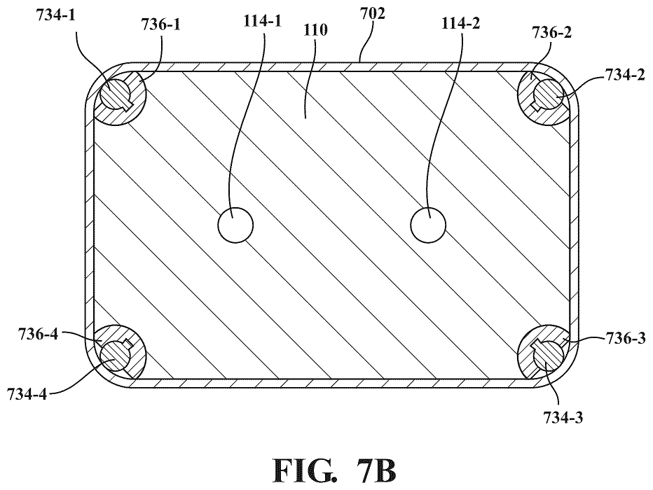

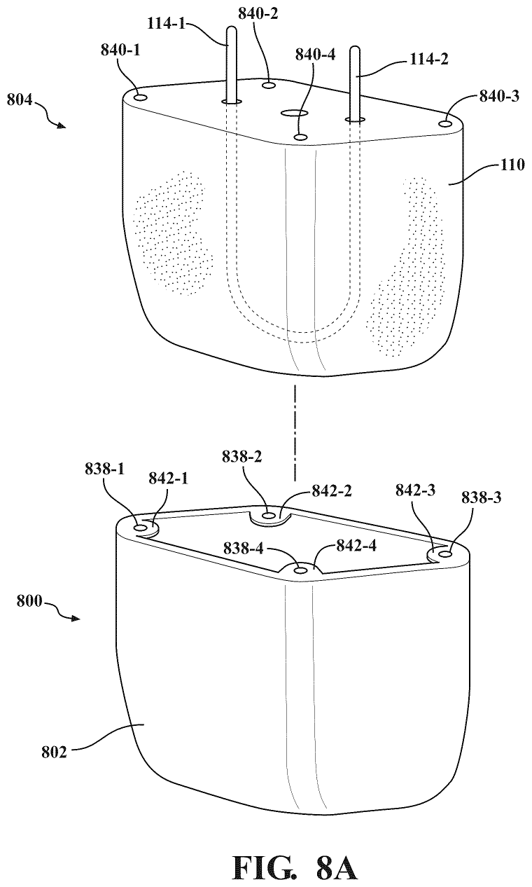

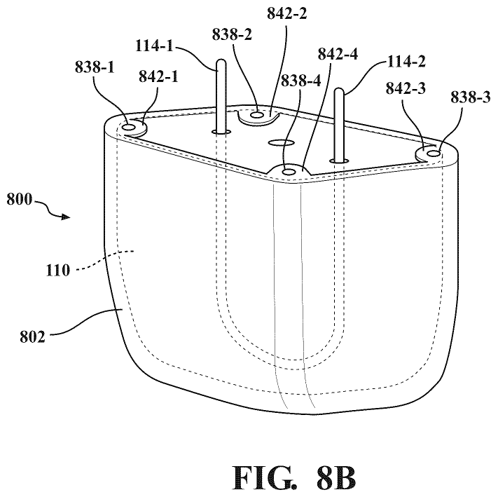

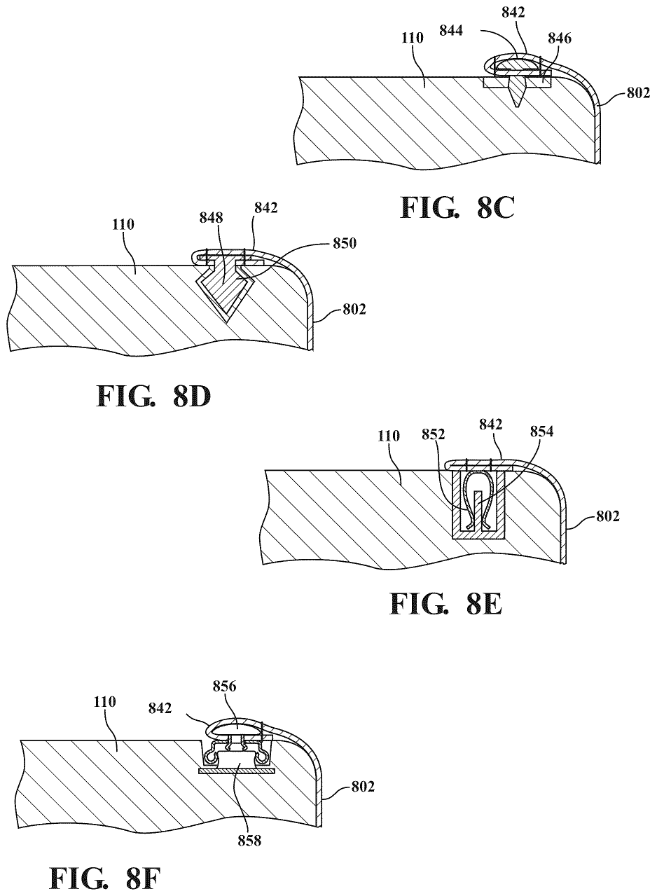

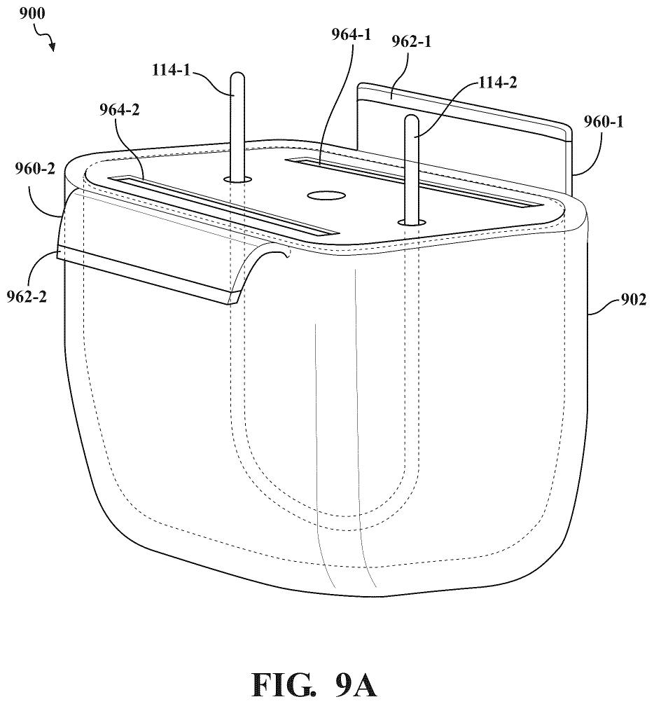

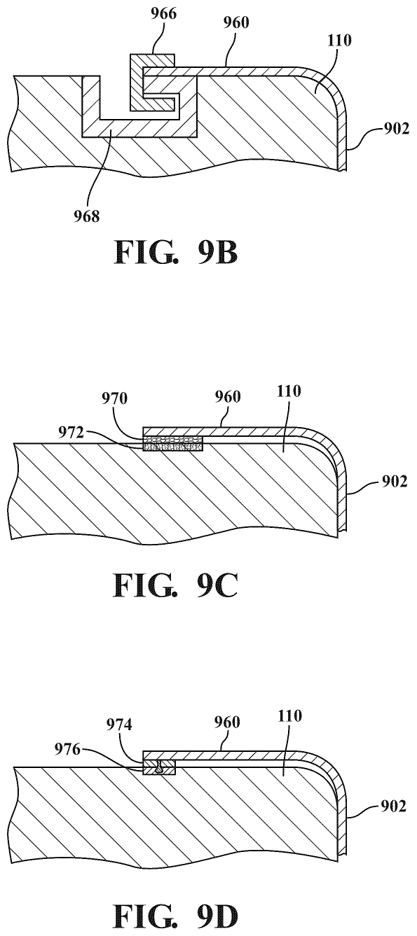

In the example depicted in FIG. 7A-9D, the headrest cover 700 includes an attachment structure affixed (e.g., sewn into) the inside of the material sleeve 702. Mating attachment structures are affixed (e.g., molded into) the exterior surface of the headrest 704. Accordingly, a user can engage the corresponding attachment structures to secure the headrest cover 700 to the headrest 704. The form of the attachment structure may vary and may include keyed grooves/protrusions (FIG. 7A), compression clips (FIGS. 8C, 8D, and 8E) , snaps (FIG. 8F) , a hook-shaped channel (FIG. 9B), a hook-and-loop fastener (FIG. 9C), and a zipper (FIG. 9D). While particular reference is made to particular attachment structures, a variety of attachment structures may be implemented in accordance with the principles described herein.

The attachment structures may be rigid or flexible. The attachment structures may formed of a material such as plastic or metal. However, the attachment structures may be formed of other materials that may be rigid or flexible, and that may hold a shape while being able to bend. Various example attachment structures will now be described.

In the example depicted in FIGS. 7A and 7B, the headrest cover 700 includes a material sleeve 702 sized to cover a front surface, a rear surface, a top surface, a first side surface, and a second side surface of a headrest 704. In an example, the material sleeve 702 may be formed of different pieces of material that are sewn together. For example, there may be vertical seams along different surfaces of the material sleeve 702. As in the example above, the material sleeve 702 may be formed of a variety of materials, including fabric, polyurethane, PVC, ripstop fabric, and/or leather.

As described above, the headrest cover 700 may include a cover attachment structure. The cover attachment structure refers to an attachment structure found on the material sleeve 702 and is used to attach the headrest cover 700 to the headrest 704. The cover attachment structure may provide a strong connection point between the headrest cover 700 and the headrest 704. As described above, the cover attachment structure may be formed of a material that can hold its shape but may bend, for example, when the headrest cover 700 is being stretched over a headrest 704.

In general, the cover attachment structure extends inward from a headrest-facing surface of the material sleeve 702. That is, the headrest attachment structures are formed on an exterior surface of the headrest 704 such that the headrest-facing cover attachment structures are positioned to interact with such. As described above, the cover attachment structures are adapted to mate with headrest attachment structures that are affixed to an exterior surface of the headrest 704.

In the example depicted in FIGS. 7A and 7B, the cover attachment structures are cover keyed shafts 734-1, 734-2, 734-3, and 734-4. The cover keyed shafts 734-1, 734-2, 734-3, and 734-4 extend vertically on the headrest-facing surface of the material sleeve 702. In general, as depicted in FIG. 7B, the cover keyed shafts 734-1, 734-2, 734-3, and 734-4 have a cross-sectional profile shape that matches, in some cases uniquely matches, a profile of vertically-arranged headrest keyed shafts 736-1, 736-2, 736-3, and 736-4 on the exterior surface of the headrest 704. As such, the cover keyed shafts 734-1, 734-2, 734-3, and 734-4 are adapted to mate with the headrest keyed shafts 736-1, 736-2, 736-3, and 736-4. As specifically depicted in FIG. 7B, the headrest keyed shafts 736-1, 736-2, 736-3, and 736-4 may include grooved channels, while the cover keyed shafts 734-1, 734-2, 734-3, and 734-4 include protrusions with cross-sectional profiles that match the grooved channels. However, in other examples, the cover keyed shafts 734-1, 734-2, 734-3, and 734-4 may include grooved channels, while the headrest keyed shafts 736-1, 736-2, 736-3, and 736-4 include the protrusions with the cross-sectional profiles that match the grooved channels.

In either case, the protrusions may extend longitudinally along the respective keyed shafts. Accordingly, during installation, a user may position the headrest cover 700 above the headrest 704, as depicted in FIG. 7A. Upon bringing the headrest cover 700 and the headrest 704 in proximity to one another, the user may align the cover keyed shafts 734-1, 734-2, 734-3, and 734-4 with the headrest keyed shafts 736-1, 736-2, 736-3, and 736-4 and slide the headrest cover 700 over the headrest 704. Note that while FIGS. 7A and 7B depict particular cross-sectional profiles for the respective keyed shafts, the keyed shafts described herein may have different cross-sectional profiles.

In an example, the cover keyed shafts 734-1, 734-2, 734-3, and 734-4 may be sewn into the material sleeve 702. That is, the material sleeve 702 may be formed of various material panels that are sewn together. In an example, the cover keyed shafts 734-1, 734-2, 734-3, and 734-4 may include a plastic or metal longitudinal protrusion, which may have small holes therein extending longitudinally. Accordingly, during installation, a user may turn the material sleeve 702 inside out and guide a thread through the apertures in the cover keyed shafts 734-1, 734-2, 734-3, and 734-4 and through the material sleeve 702 to join the cover keyed shafts 734-1, 734-2, 734-3, and 734-4 to the material sleeve 702. While particular reference is made to one particular joining modality (i.e., sewing), the cover keyed shafts 734-1, 734-2, 734-3, and 734-4 may be joined to the headrest cover 700 in different ways, such as via adhesive tape or glue. In either case, once attached, the material sleeve 702 can be turned right side out (i.e., with an occupant-facing surface facing out and a headrest-facing surface facing in) for installation over the headrest 704.

FIGS. 7A and 7B also depict the headrest 704 with the padded cushion 110 and the headrest stay 112 within the padded cushion 110. As described above, the support rods 114-1 and 114-2 extend through the bottom surface of the padded cushion 110 and are adapted to slide into headrest channels in the seat. The headrest 704 includes headrest attachment structures corresponding to the cover attachment structures. That is, the headrest attachment structures are attachment structures affixed to an exterior surface of the headrest 704 that are adapted to mate with the cover attachment structures on the material sleeve 702. As with the cover attachment structures, the headrest attachment structures may be rigid or flexible and may be formed of a material such as plastic or metal that hold their shape and position when being manipulated by a user (i.e., when the headrest cover 700 is being installed on the headrest 704), but that may bend to conform to the contours of the headrest 704.

In the example depicted in FIGS. 7A and 7B, the headrest attachment structures are headrest keyed shafts 736-1, 736-2, 736-3, and 736-4. The headrest keyed shafts 736-1, 736-2, 736-3, and 736-4 extend vertically on the exterior surface of the headrest 704. In general, as depicted in FIG. 7B, the headrest keyed shafts 736-1, 736-2, 736-3, and 736-4 have a cross-sectional profile that matches, in some cases uniquely matches, a profile of vertically-arranged cover keyed shafts 734-1, 734-2, 734-3, and 734-4 on the headrest-facing surface of the material sleeve 702. As such, the headrest keyed shafts 736-1, 736-2, 736-3, and 736-4 are adapted to mate with the cover keyed shafts 734-1, 734-2, 734-3, and 734-4. As specifically depicted in FIG. 7B the headrest keyed shafts 736-1, 736-2, 736-3, and 736-4 may include grooved channels, while the cover keyed shafts 734-1, 734-2, 734-3, and 734-4 include protrusions with cross-sectional profiles that match the grooved channels. However, in other examples, the cover keyed shafts 734-1, 734-2, 734-3, and 734-4 may include grooved channels, while the headrest keyed shafts 736-1, 736-2, 736-3, and 736-4 include the protrusions with cross-sectional profiles that match the grooved channels.

In either case, the channels may extend longitudinally along the respective keyed shafts. Accordingly, during installation, a user may position the headrest cover 700 above the headrest 704, as depicted in FIG. 7A. Upon bringing the headrest cover 700 and the headrest 704 in proximity to one another, the user may align the cover keyed shafts 734-1, 734-2, 734-3, and 734-4 with the headrest keyed shafts 736-1, 736-2, 736-3, and 736-4 and slide the headrest cover 700 over the headrest 704. Note that while FIGS. 7A and 7B depict particular cross-sectional profiles for the respective keyed shafts, the keyed shafts described herein may have different cross-sectional profiles.

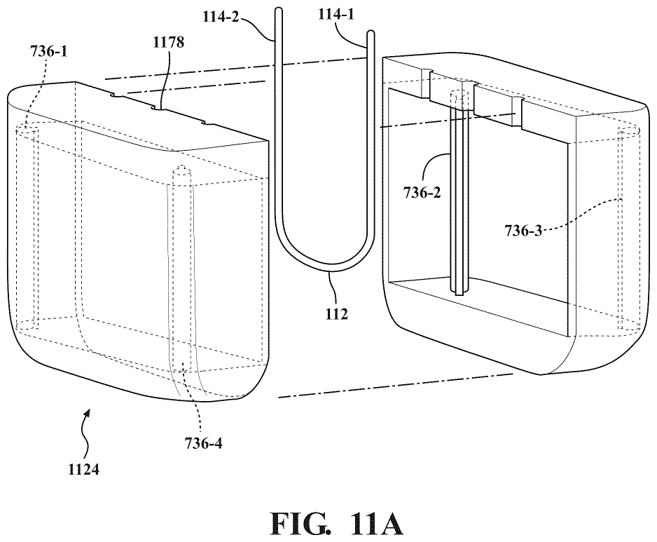

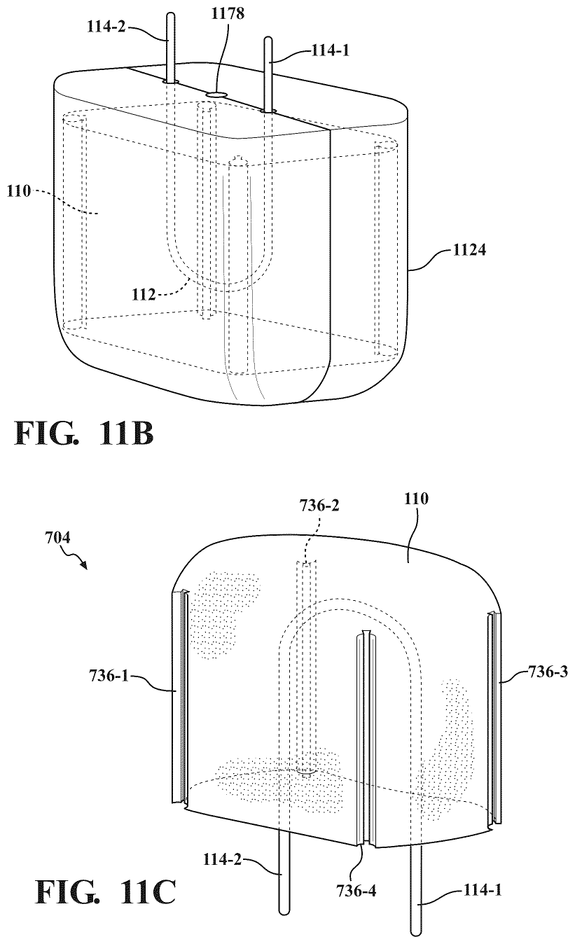

In a particular example, the headrest keyed shafts 736-1, 736-2, 736-3, and 736-4 may be molded into the headrest 704. For example, as depicted in FIG. 11A-11C, the headrest keyed shafts 736-1, 736-2, 736-3, and 736-4 may be placed on an exterior wall of the headrest mold such that when foam or liquid reactants are injected into the headrest mold, the headrest keyed shafts 736-1, 736-2, 736-3, and 736-4 become embedded in the padded cushion 110, with the headrest keyed shafts 736-1, 736-2, 736-3, and 736-4 exposed and facing outward. Note that while FIGS. 7A and 7B depict the cover keyed shafts 734-1, 734-2, 734-3, and 734-4 and headrest keyed shafts 736-1, 736-2, 736-3, and 736-4 positioned at various locations on the respective components, specifically along vertical edges of the respective components, the cover keyed shafts 734-1, 734-2, 734-3, and 734-4 and headrest keyed shafts 736-1, 736-2, 736-3, and 736-4 may be vertically positioned at other locations, such as mid-plane positions along the side surfaces or the back surfaces.

FIG. 8A-8F are views of a headrest cover 800 with integrated attachment structures according to embodiments described herein. Specifically, FIG. 8A-8F depict examples of the cover attachment structure and the headrest attachment structure. In the examples depicted in FIG. 8A-8F, the cover attachment structures of the headrest cover 800 are press-fit features 838-1, 838-2, 838-3, and 838-4 that are adapted to mate with a set of fixtures 840-1, 840-2, 840-3, and 840-4 on the exterior surface of the padded cushion 110. Specifically, in an example, the press-fit features 838-1, 838-2, 838-3, and 838-4 are formed on flaps 842-1, 842-2, 842-3, and 842-4 of the material sleeve 802 that, once the material sleeve 802 is installed over the headrest 804, fold around to interface with the fixtures 840-1, 840-2, 840-3, and 840-4. Note that while FIGS. 8A and 8B depict the flaps 842-1, 842-2, 842-3, and 842-4 in particular locations on the material sleeve 802 (i.e., the corners), the flaps 842-1, 842-2, 842-3, and 842-4 may be positioned at any other location of the material sleeve 802.

FIG. 8B depicts an assembled view where the headrest 804 has been inserted through the opening of the material sleeve 802, and the press-fit features 838-1, 838-2, 838-3, and 838-4 have been engaged with the respective fixtures 840-1, 840-2, 840-3, and 840-4. Specifically, the flaps 842-1, 842-2, 842-3, and 842-4 are flipped to a position where the press-fit features 838-1, 838-2, 838-3, and 838-4 do not interfere with the insertion of the headrest 804 into the material sleeve 802. Following insertion, the flaps 842-1, 842-2, 842-3, and 842-4 are flipped to a position below the bottom surface of the headrest 804 and the press-fit features 838-1, 838-2, 838-3, and 838-4 are pressed into the fixtures 840-1, 840-2, 840-3, and 840-4 that are molded into or otherwise affixed to the bottom surface of the headrest 804.

In an example the press-fit features 838-1, 838-2, 838-3, and 838-4, and the fixtures 840-1, 840-2, 840-3, and 840-4 may be formed of a rigid material such as a plastic or metal. In either case, the press-fit features 838-1, 838-2, 838-3, and 838-4, and the fixtures 840-1, 840-2, 840-3, and 840-4 may be joined to their respective components as described above. For example, the press-fit features 838-1, 838-2, 838-3, and 838-4 may be sewn into or adhered to the material sleeve 802, while the fixtures 840-1, 840-2, 840-3, and 840-4 may be molded into the padded cushion 110. For example, the fixtures 840-1, 840-2, 840-3, and 840-4 may be placed within a headrest mold at locations where, once the foam and/or liquid reactants are injected and cured, the fixtures 840-1, 840-2, 840-3, and 840-4 become embedded in the padded cushion 110, with the fixtures 840-1, 840-2, 840-3, and 840-4 exposed and facing outward. In another example, the fixtures 840-1, 840-2, 840-3, and 840-4 may be positioned on the exposed bottom surface of the foam as it is cured.

FIG. 8C-8F depict various example press-fit features 838-1, 838-2, 838-3, and 838-4. Specifically, as depicted in FIG. 8C, the press-fit features 838-1, 838-2, 838-3, and 838-4 may be push clips 844. Specifically, the push clips 844 may include an insertion end with a slit or shape that elastically deforms after passing through a corresponding narrow opening fixture 846. Forces between the push clips 844 and the narrow opening fixtures 846 cause the push clips 844 to deflect inward. Once through the narrow opening fixture 846, the insertion end of the push clip 844 expands diametrically, securing the headrest cover 800 in place over the headrest 804. To remove the headrest cover 800, a user would grasp the push clips 844 or the flaps 842-1, 842-2, 842-3, and 842-4 on which the push clips 844 are affixed, and pull the push clips 844 out of the associated narrow opening fixtures o which may cause the insertion end to deflect inward to a size where the push clips 844 can be extracted from the molded narrow opening fixtures 846.

As depicted in FIG. 8D, the press-fit features 838-1, 838-2, 838-3, and 838-4 may be arrow-shaped clips 848. In this example, the headrest attachment structure includes lipped opening fixtures 850. As the arrow-shaped clips 848 are inserted through the lipped opening fixtures 850, the leading edges of the arrow-shaped clips 848 cause the lipped opening fixtures 850 to deflect outward. Once the leading edge has passed through the lipped opening fixture 850, the lipped opening fixture 850 returns to an undeflected position, securing the headrest cover 800 in place over the headrest 804, as depicted in FIG. 8D. To remove the headrest cover 800, a user would grasp the arrow-shaped clips 848 or the flaps 842-1, 842-2, 842-3, and 842-4 on which the arrow-shaped clips 848 are affixed, and pull the arrow-shaped clips 848 out of the associated lipped opening fixture 850, which may cause the lipped opening fixtures 850 to deflect outward to a size where the arrow-shaped clips 848 can be extracted from the lipped opening fixtures 850.

As depicted in FIG. 8E, the press-fit features 838-1, 838-2, 838-3, and 838-4 may be U-shaped compression clips 852. The U-shaped compression clips 852 include an inflection point where the arms of the U-shaped compression clips 852 deflect inward to contact one another. In this example, the headrest attachment structure includes a vertical protrusion 854, which vertical protrusion 854 may include a bulge around which the arms of the U-shaped compression clips 852 deflect. As the U-shaped compression clips 852 are inserted through the opening and the U-shaped compression clip 852 arms deflect around the protrusion 854 and optionally the bulge on the protrusion 854. Interface and friction forces between the inflection points on either U-shaped compression clip 852 arm and the protrusion 854 secure the headrest cover 800 in place over the headrest 804 as depicted in FIG. 8E. To remove the headrest cover 800, a user would grasp the U-shaped compression clips 852 or the flaps 842-1, 842-2, 842-3, and 842-4 on which the U-shaped compression clips 852 are affixed, and pull the U-shaped compression clips 852 away from the protrusion 854.

As depicted in FIG. 8F, the press-fit features 838-1, 838-2, 838-3, and 838-4 may be studs 856, which include a small protrusion with an enlarged head. In this example, the headrest attachment structure includes a socket 858 with an opening in which the enlarged head of the studs 856 rests. Responsive to user force, the enlarged head of the stud 856 is positioned within the socket 858, where it is retained in position. Interface and friction forces between the enlarged head and the socket 858 secure the headrest cover 800 in place over the headrest 804, as depicted in FIG. 8F. To remove the headrest cover 800, a user would grasp the stud 856 or the flaps 842 on which the studs 856 are affixed, and pull the stud 856 out of the associated socket 858. Note that while FIG. 8A-8F depict various types of press-fit features, other types of press-fit features may be implemented in accordance with the principles described herein.

FIG. 9A-9D are views of a headrest cover 900 with integrated attachment structures according to embodiments described herein. As described above, the cover attachment structure and the corresponding headrest attachment structure may take various forms. In the example depicted in FIG. 8A-8F, the press-fit features 838-1, 838-2, 838-3, and 838-4, and the associated fixtures 840 were located at the corners of the respective components. In the examples depicted in FIG. 9A-9D, the attachment structures span a width of the respective components. Specifically, the material sleeve 902 is sized to cover at least a portion of the bottom surface of the headrest 904, and the cover attachment structure is formed on a portion of the material sleeve 902 that faces the bottom surface of the padded cushion 110.

Specifically, width-wide flaps 960-1 and 960-2 of the material sleeve 902 extend away from the body of the material sleeve 902. During insertion of the padded cushion 110, the width-wide flaps 960-1 and 960-2 are flipped to a position where the cover attachment structures 962-1 and 962-2 do not interfere with the insertion of the padded cushion 110 into the material sleeve 902. Following insertion, the width-wide flaps 960-1 and 960-2 are flipped to a position below the bottom surface of the padded cushion 110, and the cover attachment structures 962-1 and 962-2 are engaged with the corresponding headrest attachment structure fixtures 964-1 and 964-2 that are molded into or otherwise affixed to the bottom surface of the headrest 804. While FIG. 9A depicts a particular length for the width-wide flaps 960-1 and 960-2, the width-wide flaps 960-1 and 960-2 may have various lengths, depending on the desired coverage of the bottom surface of the padded cushion 110. In one example, the width-wide flaps 960-1 and 960-2 wrap across the bottom surface past the support rods 114-1 and 114-2. Accordingly, the width-wide flaps 960-1 and 960-2 may have notches that align with the support rods 114-1 and 114-2. In other examples, the width-wide flaps 960-1 and 960-2 may extend a shorter distance across the bottom surface such that there may be exposed padded cushion 110 between the width-wide flaps 960-1 and 960-2.

In the example depicted in FIG. 9B, the cover attachment structure 962-1 and 962-2 is a first hook-shaped channel 966 along an edge of the material sleeve 902. Specifically, the first hook-shaped channel 966 is disposed on a corresponding width-wide flap 960. As depicted in FIGS. 9A and 9B, the first hook-shaped channel 966 may extend along the entirety of the width-wide flap 960. The corresponding second hook-shaped channel 968 extends along the width of the padded cushion 110. The hook-shaped channel 966 may be joined to the corresponding width-wide flap 960 in a variety of ways. For example, the hook-shaped channel 966 may be sewn to the width-wide flap 960, which is made of fabric. While particular reference is made to one particular joining modality (i.e., sewing), the hook-shaped channel 966 may be joined to the width-wide flap 960 in different ways, such as via adhesive tape or glue. In either case, once attached, the hook-shaped channel 966 may affix the headrest cover 900 to the padded cushion 110. That is, the headrest attachment structure may include a fixture adapted to receive and retain the first hook-shaped channel 966. As depicted in FIG. 9B, the headrest attachment structure may be a second hook-shaped channel 968 that is molded into the exterior surface of the headrest.

In a particular example, the second hook-shaped channel 968 may be molded into the padded cushion 110. For example, as depicted in FIG. 11A-11C, after foam or liquid reactants are injected into a headrest mold, the second hook-shaped channel 968 may be positioned on the exposed bottom surface of the foam as it is cured. Once cured, the second hook-shaped channel 968 may become embedded in the padded cushion 110, with the second hook-shaped channel 968 exposed and facing outward. In another example, the second hook-shaped channel 968 may be positioned on a portion of the headrest mold that defines the bottom surface of the headrest. Accordingly, as foam or liquid reactants are injected into the headrest mold, the second hook-shaped channel 968 is embedded into the exterior face of the padded cushion 110, as depicted in FIG. 9B.

During installation, a user may insert the padded cushion 110 through the opening in the headrest cover 900. Before insertion of the padded cushion 110, the width-wide flaps 960-1 and 960-2 are flipped to a position where the corresponding first hook-shaped channel(s) 966 do not interfere with the insertion of the padded cushion 110 into the material sleeve 902. Following insertion, the width-wide flaps 960-1 and 960-2 are flipped to a position below the bottom surface of the padded cushion 110. The user may stretch the material sleeve 902 until the hook of the first hook-shaped channel 966 is beyond the hook of the second hook-shaped channel 968. Upon release, the elastic recovery of the material sleeve 902 draws the hook-shaped channels 966 and 968 into contact with one another, thus affixing the headrest cover 900 to the headrest.

In the example depicted in FIG. 9C, the cover attachment structure 962-1 and 962-2 is a first portion 970 of a hook-and-loop fastener along the edge of the material sleeve 902. Specifically, the first portion 970 of a hook-and-loop fastener is disposed on a corresponding width-wide flap 960. As depicted in FIGS. 9A and 9C, the first portion 970 of a hook-and-loop fastener may extend along the entirety of the width-wide flap 960. The corresponding second portion 972 of the hook-and-loop fastener may extend along the width of the padded cushion 110. The portions of the hook-and-loop fastener may be joined to the corresponding width-wide flaps 960 in a variety of ways. For example, the first portion 970 of the hook-and-loop fastener may be sewn to the width-wide flap 960, formed from a fabric material. While particular reference is made to one particular joining modality (i.e., sewing), the first portion 970 of a hook-and-loop fastener may be joined to the headrest cover 900 in different ways, such as via adhesive tape or glue. In either case, once attached, the first portion 970 of a hook-and-loop fastener may affix the headrest cover 900 to the padded cushion 110. That is, the headrest attachment structure may include a fixture adapted to receive and retain the first portion 970 of a hook-and-loop fastener. As depicted in FIG. 9C, the headrest attachment structure may be a second portion 972 of a hook-and-loop fastener that is molded into the exterior surface of the padded cushion 110.

In a particular example, the second portion 972 of a hook-and-loop fastener may be molded into the padded cushion 110. For example, as depicted in FIG. 11A-11C, after foam or liquid reactants are injected into a headrest mold, the second portion 972 of a hook-and-loop fastener may be positioned on the exposed bottom surface of the foam as it cures. Once cured, the second portion 972 of a hook-and-loop fastener becomes embedded in the padded cushion 110, with the second portion 972 of a hook-and-loop fastener exposed and facing outward. In another example, the second portion 972 of a hook-and-loop fastener may be positioned on a portion of the headrest mold that defines the bottom surface of the padded cushion 110. Accordingly, as foam or liquid reactants are injected into the headrest mold, the second portion 972 of a hook-and-loop fastener is embedded into the exterior face of the padded cushion 110, as depicted in FIG. 9C.

During installation, a user may insert the padded cushion 110 through the opening in the headrest cover 900. Before insertion of the padded cushion 110, the width-wide flaps 960-1 and 960-2 are flipped to a position where the first portion(s) 970 of a hook-and-loop fastener do not interfere with the insertion of the padded cushion 110 into the material sleeve 902. Following insertion, the width-wide flaps 960-1 and 960-2 are flipped to a position below the bottom surface of the padded cushion 110. The user may press the first portion 970 of a hook-and-loop fastener against the second portion 972 of the hook-and-loop fastener, thus affixing the headrest cover 900 to the padded cushion 110. Note that in this example, either the first portion or the second portion may include hooks. For example, the first portion 970 of the hook-and-loop fastener may include hooks on a fabric base, while the second portion 972 of the hook-and-loop fastener may include loops on a fabric base. In another example, the first portion 970 of the hook-and-loop fastener may include loops on a fabric base, while the second portion 972 of the hook-and-loop fastener may include hooks on a fabric base.

In the example depicted in FIG. 9D, the cover attachment structure 962-1 and 962-2 is a first zipper portion 974 along the edge of the material sleeve 902. Specifically, the first zipper portion 974 is disposed on a corresponding width-wide flap 960. As depicted in FIGS. 9A and 9D, the first zipper portion 974 may extend along the entirety of the width-wide flap 960. The corresponding second zipper portion 976 may extend along the width of the padded cushion 110. The zipper portions may be joined to the corresponding width-wide flaps 960 in various ways. For example, the first zipper portion 974 may be sewn to the width-wide flap 960, formed from a fabric material. While particular reference is made to one particular joining modality (i.e., sewing), the first zipper portion 974 may be joined to the headrest cover 900 in different ways, such as via adhesive tape or glue. In either case, once attached, the first zipper portion 974 may affix the headrest cover 900 to the padded cushion 110. That is, the headrest attachment structure may include the second zipper portion 976 on the exterior surface of the padded cushion 110, adapted to mate with the first zipper portion 974 along the edge of the material sleeve 902.

In a particular example, the second zipper portion 976 may be molded into the padded cushion 110. For example, as depicted in FIG. 11A-11C, after foam or liquid reactants are injected into a headrest mold, the second zipper portion 976 may be positioned on the exposed bottom surface of the foam as it cures. Once cured, the second zipper portion 976 becomes embedded in the padded cushion 110, with the second zipper portion 976 exposed and facing outward. In another example, the second zipper portion 976 may be positioned on a portion of the headrest mold that defines the bottom surface of the padded cushion 110. Accordingly, as foam or liquid reactants are injected into the headrest mold, the second zipper portion 976 is embedded into an exterior face of the padded cushion 110, as depicted in FIG. 9D.

During installation, a user may insert the padded cushion 110 through the opening in the headrest cover 900. Before insertion of the padded cushion 110, the width-wide flaps 960-1 and 960-2 are flipped to a position where the first zipper portion 974 does not interfere with the insertion of the padded cushion 110 into the material sleeve 902. Following insertion, the width-wide flaps 960-1 and 960-2 are flipped to a position below the bottom surface of the padded cushion 110. The user may then advance a slider along the first zipper portion 974 and the second zipper portion 976 to enmesh the teeth of the corresponding zipper portions, thus affixing the headrest cover 900 to the headrest.

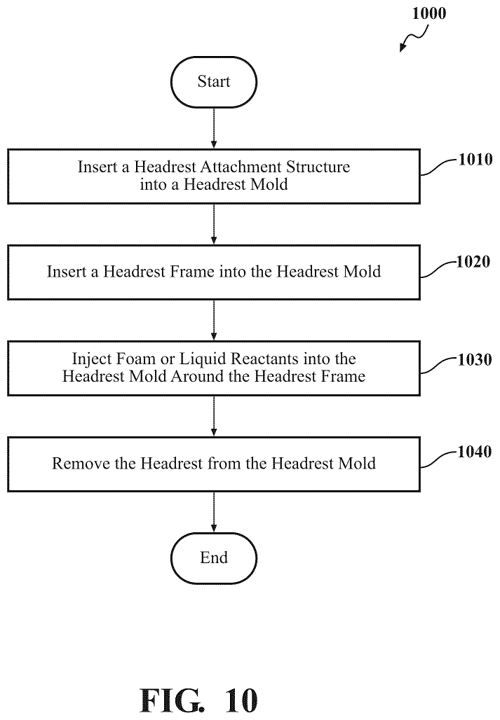

FIG. 10 is a flowchart depicting a method 1000 of forming a headrest cover 800 and 900 with integrated attachment structures according to an embodiment described herein. FIG. 11A-11C pictorially represents the steps described herein. At 1010, headrest attachment structures are inserted into a headrest mold 1124, as depicted in FIG. 11A. That is, an interior volume of the headrest mold 1124 may be accessible. In the example depicted in FIG. 11A, the headrest mold 1124 is divided into two halves, with the shape of the interior volume defining the ultimate shape of the padded cushion 110. In this example, the headrest attachment structures are adhered to the appropriate walls of the headrest mold 1124. For example, in FIG. 11A-11C, the headrest attachment structures are the headrest keyed shafts 736-1, 736-2, 736-3, and 736-4. In this example, a technician may position the headrest keyed shafts 736-1, 736-2, 736-3, and 736-4 at appropriate locations, in this example, along the vertical edges of the headrest mold 1124. In other cases, where the headrest attachment structure has another structure (i.e., fixtures for press-fit features, hook-shaped channels, or halves of hook-and-loop fasteners or zippers), the headrest attachment structure may be positioned on another portion of the headrest mold 1124 wall, for example, a wall of the headrest mold 1124 that defines the bottom surface of the padded cushion 110.

The headrest attachment structures may be attached to the walls of the headrest mold 1124 in a variety of ways. For example, the headrest attachment structures may include a magnetic material, which may affix the headrest attachment structure to a metallic headrest mold 1124. In another example, the headrest attachment structures may be adhered to the headrest mold 1124 via a temporary adhesive. Other modalities may similarly affix the headrest attachment structures to the inside of the headrest mold 1124 in a position such that as a padded cushion 110 is formed, the headrest attachment structures are formed on exterior faces of such.

Also as depicted in FIG. 11A, at 1020 the headrest stay 112 (along with the attached support rods 114-1 and 114-2) may be inserted into the headrest mold 1124. The headrest mold 1124 is an injection cavity formed in a target shape for the headrest such that when foam or liquid reactants are added therein and allowed to expand and cure, the foam takes the form of the headrest mold 1124, which is the desired shape for the headrest 104. Once inserted, the headrest mold 1124 may be closed and prepared for foam or liquid reactant injection.

At 1030, foam or liquid reactants may be injected into the headrest mold 1124 around the headrest stay 112 and the headrest attachment structures, as depicted in FIG. 11B. In this example, the headrest mold 1124 may include an aperture 1178. The aperture 1178 receives a nozzle through which the foam or liquid reactants are injected into the headrest mold 1124 to form the padded cushion 110.

The injected material may take a variety of forms. For example, liquid foam may be injected into the headrest mold 1124. The injected liquid foam may take a variety of forms. For example, the foam may be an open-cell foam, a closed-cell foam, or other injectable-type foam. In an example, the foam is an expandable foam that, when injected into the headrest mold 1124, expands to fill the volume of the injection cavity.

In another example, liquid reactants, rather than foam, are injected into the headrest mold 1124. For example, different liquids may be injected into the headrest mold 1124. A chemical reaction between these liquids may result in the polyurethane foam that makes up the padded cushion 110. While particular reference is made to particular injectable components (i.e., liquids or foams), other types of injectable liquids and/or foams may be implemented in accordance with the principles described herein. During formation, the headrest attachment structures, in whatever form, may become embedded in the padded cushion 110 and may adhere or bond to the curing foam.

In either case, at 1040, as depicted in FIG. 11C, the headrest 704 is removed from the headrest mold 1124. As described above, the padded cushion 110 1) has the shape of the headrest mold 1124 and 2) has the headrest attachment structures affixed thereto so that the headrest cover 900 may be removably attached to the headrest 704.

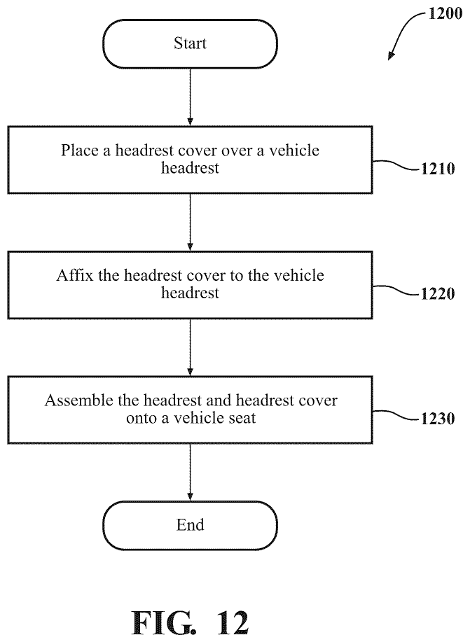

FIG. 12 is a flowchart depicting a method 1200 of installing a headrest cover in accordance with an embodiment described herein. The method 1200 may be implemented to install a zipper-based headrest cover, as depicted in FIG. 1-6B or an attachment structure-based headrest cover, as depicted in FIG. 7 A-11C. For the installation of either headrest cover, at 1210, a user may wrap a material sleeve 102, 602, 702, 802, or 902 over a headrest 104, 704, 804, or 904. As described above, the headrest may have a front, rear, top, first side, second side, and bottom surfaces. The material sleeve may be adapted to cover the front, rear, top, first side, and second side surfaces. The bottom surface of the headrest may be exposed or covered by a base headrest cover 106.

At 1220, a user affixes the headrest cover to the vehicle headrest. This may occur in various ways depending on the type of headrest cover. For example, for a zipper-based headrest cover 100 and 600, a user may join the first zipper portion 108, positioned around a perimeter or border of the material sleeve 102 and 602, to the second zipper portion 116, which is positioned around a border of the headrest, whether attached to the base headrest cover 106 or the impermeable bag 222, either of which is adhered or otherwise integrated with the padded cushion 110 of the headrest 104.

For an attachment structure-based headrest cover 700, 800, and 900, a user aligns respective cover attachment structures and headrest attachment structures and manipulates the headrest cover 700, 800, and 900 to engage the corresponding features, examples of which are described above.

In either case, at 1230, a user may insert the support rods 114-1 and 114-2 into headrest channels on the backrest of the vehicle seat. As such, the method 1200 described herein provides for a headrest where the headrest cover is readily removed to allow for repair and/or replacement of the fabric without having to dispose of the entire headrest.

In the above detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A headrest cover, comprising:
a material sleeve sized to cover a front surface, a rear surface, a top surface, a first side surface, and a second side surface of a headrest of a seat; and
a first zipper portion disposed around a bottom edge of the material sleeve, the first zipper portion is adapted to be joined with a second zipper portion affixed around a perimeter of a bottom surface of the headrest.

2. The headrest cover of claim 1, wherein the material sleeve comprises a relief structure adapted to expand as the material sleeve is wrapped over the headrest.

3. The headrest cover of claim 2, wherein the relief structure is formed on a back side of the material sleeve.

4. The headrest cover of claim 2, wherein the relief structure comprises at least one of:
an open slit in the material sleeve; or
a slit in the material sleeve filled with an elastically deformable material, the elastically deformable material is different than a material of the material sleeve.

5. The headrest cover of claim 1, wherein the first zipper portion comprises a tail section, extending away from the material sleeve, adapted to be joined with a second zipper portion tail section that extends away from the headrest.

6. The headrest cover of claim 1, further comprising a bolster disposed on a headrest-facing side of a front surface of the material sleeve.

7. A headrest, comprising:
a padded cushion;
support rods within the padded cushion, the support rods extend through a bottom surface of the padded cushion, the support rods are adapted to slide into headrest channels in a seat; and
a second zipper portion disposed around a perimeter of the bottom surface of the padded cushion, the second zipper portion is adapted to be joined with a first zipper portion disposed around a bottom edge of a headrest cover.

8. The headrest of claim 7:
further comprising an impermeable bag covering a front surface, a rear surface, a top surface, a first side surface, and a second side surface of the padded cushion; and
wherein the second zipper portion is attached to an edge of the impermeable bag.

9. The headrest of claim 7:
further comprising a base headrest cover sized to cover the bottom surface of the padded cushion and attached to the bottom surface of the padded cushion; and
wherein the second zipper portion is attached to a perimeter of the base headrest cover.

10. The headrest of claim 9, wherein the base headrest cover is attached to an impermeable bag that covers a front surface, a rear surface, a top surface, a first side surface, and a second side surface of the padded cushion.

11. The headrest of claim 9, wherein the base headrest cover further comprises an aperture, the aperture receives a nozzle through which foam or liquid reactants are injected into a headrest mold to form the padded cushion.

12. The headrest of claim 7, wherein the second zipper portion comprises a tail section, extending away from the padded cushion, adapted to be joined with a first zipper portion tail section that extends away from the headrest cover.

13. A headrest cover, comprising:
a material sleeve sized to cover a front surface, a rear surface, a top surface, a first side surface, and a second side surface of a headrest of a seat; and
a cover attachment structure that extends inward from a headrest-facing surface of the material sleeve, the cover attachment structure is adapted to mate with a headrest attachment structure that is affixed to an exterior surface of the headrest.

14. The headrest cover of claim 13, wherein the cover attachment structure comprises cover keyed shafts that extend vertically on the headrest-facing surface of the material sleeve, the cover keyed shafts are adapted to mate with vertically-arranged headrest keyed shafts on the exterior surface of the headrest.

15. The headrest cover of claim 13, wherein the cover attachment structure comprises press-fit features adapted to mate with fixtures on the exterior surface of the headrest.

16. The headrest cover of claim 13, wherein the cover attachment structure comprises a first hook-shaped channel along an edge of the material sleeve, the first hook-shaped channel is adapted to mate with a second hook-shaped channel on the exterior surface of the headrest.

17. The headrest cover of claim 13, wherein the cover attachment structure comprises a first portion of a hook-and-loop fastener along an edge of the material sleeve, the first portion of the hook-and-loop fastener is adapted to mate with a second portion of the hook-and-loop fastener on the exterior surface of the headrest.

18. The headrest cover of claim 13, wherein the cover attachment structure comprises a first zipper portion along an edge of the material sleeve, the first zipper portion is adapted to mate with a second zipper portion on the exterior surface of the headrest.

19. The headrest cover of claim 13, wherein:
the material sleeve is further sized to cover at least a portion of a bottom surface of the headrest; and
the cover attachment structure is formed on a portion of the material sleeve that faces the bottom surface of the headrest.

20. A headrest, comprising:
a padded cushion;
support rods within the padded cushion, the support rods extend through a bottom surface of the padded cushion, the support rods are adapted to slide into a pair of headrest channels in a seat; and
a headrest attachment structure affixed to an exterior surface of the headrest, the headrest attachment structure is adapted to mate with a cover attachment structure that extends inward from a headrest-facing surface of a headrest cover.

21. The headrest of claim 20, wherein the headrest attachment structure is molded into the exterior surface of the headrest.

22. The headrest of claim 20, wherein the headrest attachment structure comprises headrest keyed shafts that extend vertically on the exterior surface of the headrest, the headrest keyed shafts are adapted to mate with vertically-arranged cover keyed shafts on a headrest-facing surface of the headrest cover.

23. The headrest of claim 20, wherein the headrest attachment structure comprises fixtures adapted to receive and retain at least one of:
press-fit features on the headrest-facing surface of the headrest cover; or
a hook-shaped channel along an edge of the headrest cover.

24. The headrest of claim 20, wherein the headrest attachment structure comprises a second portion of a hook-and-loop fastener on the exterior surface of the headrest, the second portion of the hook-and-loop fastener is adapted to mate with a first portion of the hook-and-loop fastener along an edge of the headrest cover.

25. The headrest of claim 20, wherein the headrest attachment structure comprises a second zipper portion on the exterior surface of the headrest, the second zipper portion is adapted to mate with a first zipper portion along an edge of the headrest cover.
